(19) United States
(12) Patent Application Publication
(10) Pub. No.: US 2020/0265345 A1
(43) Pub. Date: Aug. 20, 2020

(54) INFORMATION PROCESSING DEVICE, INFORMATION PROCESSING METHOD, AND PROGRAM

(71) Applicant: Toyota Jidosha Kabushiki Kaisha, Toyota-shi (JP)

(72) Inventors: Kazuyuki Ishiwata, Toyota-shi (JP); Takayuki Yano, Nisshin-shi (JP); Shin Sakurada, Toyota-shi (JP); Megumi Amano, Toyota-shi (JP)

(73) Assignee: Toyota Jidosha Kabushiki Kaisha, Toyota-shi (JP)

(21) Appl. No.: 16/751,489

(22) Filed: Jan. 24, 2020

(30) Foreign Application Priority Data
Feb. 14, 2019 (JP) 2019-024584

(51) Int. Cl. G06Q 10/02; G08G 1/14; G06Q 10/08; G06Q 30/00; G06Q 10/04; G01C 21/36

(52) U.S. Cl. CPC G06Q 10/02; G08G 1/146; G06Q 10/083; G06Q 2240/00; G06Q 10/047; G01C 21/3685; G06Q 30/018

(57) ABSTRACT

An information processing device is equipped with a control unit that carries out acquisition of desire information including information indicating an operation that is performed during halt of a vehicle, and information indicating a time during which the vehicle is desired to be halted, acquisition of halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place, and output of the halt place-associated information.

### INCORPORATION BY REFERENCE

The disclosure of Japanese Patent Application No. 2019-024584 filed on Feb. 14, 2019 including the specification, drawings and abstract is incorporated herein by reference in its entirety.

### BACKGROUND

### 1. Technical Field

The disclosure relates to an information processing device, an information processing method, and a program.

### 2. Description of Related Art

There is a parking lot reservation system that searches a vacant parking lot matching information including a desired destination for parking and a desired time zone for parking, that informs a user of a place permitting parking if there is any, and that makes it possible to reserve the same or a plurality of parking lots for each of different time zones when the user inputs the information from a portable terminal etc. such as a smartphone or the like (e.g., Japanese Patent Application Publication No. 2018-084906 (JP 2018-084906 A)).

Besides, there is a method of referring to information on vehicle positions and information on the opening/closing of vehicle doors based on probe information uploaded from a plurality of vehicles, and extracting and proposing a place that makes it easy to halt each of the vehicles and that is suited for a rendezvous between a passenger of each of the vehicles and a pedestrian, based on information on the positions of the vehicles whose doors have been opened/closed within a range that is specified with respect to a required and designated position (e.g., Japanese Patent Application Publication No. 2013-020517 (JP 2013-020517 A)).

Besides, there is a device that is equipped with a delivery database that stores data on recommended halt positions to be recommended as halt positions during delivery operation as to each client, a computation unit that prioritizes the recommended halt positions as to each client to which goods should be delivered, based on at least running situation data including a current position of a vehicle and a current time and data on the recommended halt positions, and a display unit that displays the recommended halt positions for each client according to orders of priority obtained by the computation unit (e.g., Japanese Patent Application Publication No. 2001-076285 (JP 2001-076285 A)).

### SUMMARY

The disclosure aims at providing an information processing device, an information processing method, and a program that make it possible to halt a vehicle at a place managed by a user and perform a desired operation.

One aspect of the disclosure is an information processing device that is equipped with a control unit that carries out acquisition of desire information including information indicating an operation that is performed during halt of a vehicle, and information indicating a time during which the vehicle is desired to be halted, acquisition of halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place, and output of the halt place-associated information.

According to the disclosure, it is possible to halt the vehicle at the place managed by the user and perform the desired operation.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of a system according to one of the embodiments;

FIG. 2 shows a configuration example of a terminal 20 that can be used as each of terminals shown in FIG. 1;

FIG. 3 shows a configuration example of a server;

FIG. 4 shows a data structure example of a database (DB) in which vehicle halt permitting place information is stored;

FIG. 5 shows an example of facility information;

FIG. 6 shows a data structure example of a support vehicle database;

FIG. 7 is a flowchart showing an exemplary process that is performed in a computer system including the server and the terminals;

FIG. 8 is an illustrative view of desire information;

FIG. 9 is a flowchart showing an exemplary process of searching a vehicle halt permitting place; and

FIG. 10 is a flowchart showing an exemplary process of searching a support vehicle.

### DETAILED DESCRIPTION OF EMBODIMENTS

In one of the embodiments, an information processing device that is equipped with a control unit that performs the following will be described.

(1) The control unit acquires desire information including information indicating an operation performed during halt of a vehicle, and information indicating a time during which the vehicle is desired to be halted.

(2) The control unit acquires halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place.

(3) The control unit outputs the halt place-associated information.

“The vehicle” is utilized to provide a service. The service includes the sales of merchandise, the delivery of people and goods, or the like. The vehicle is utilized as, for example, a movable shop or a delivery car. The vehicle may be automatically driven or driven by a person riding therein. “The operation that is performed during halt” includes an operation regarding the inspection, maintenance, and repair of the vehicle, the clearance and cleaning of the interior of the vehicle, the rearrangement of facilities in the vehicle, the renovation thereof, the loading/unloading of cargo (the replacement of goods (the unloading of goods, the loading of goods)), or the like. It should be noted, however, that the operation that is performed during halt is not limited to these, but can include, for example, various acts for preparing for business. The cargo includes articles installed in the vehicle, a passenger's belongings, merchandise and things (articles installed in a shop or a business office) contributing to the provision of merchandise and services in the case where the vehicle is utilized to provide various services including the sale of merchandise, or the like, but is not limited thereto.

A transmitter of the desire information (referred to as a desirer) is, for example, the passenger of the vehicle. However, someone other than the passenger of the vehicle (a manager for the passenger of the vehicle) may transmit this desire information. “The user” is a person who provides the vehicle halt permitting place, and is, for example, a member (user) who utilizes the service (e.g., a shop) using the vehicle. The vehicle halt permitting place is a place that is managed by the user and that permits the vehicle to be halted (a land or a building). The expression “managed by the user” means that the user has the right to permit or prohibit halt of the vehicle at the vehicle halt permitting place. For example, the user is someone who owns the land or the building as the vehicle halt permitting place, or someone who is vested with the right to determine the possibility of halting the vehicle at the vehicle halt permitting place by an owner or the like of the land or the building.

“Halt” also includes a halt longer than a predetermined time (e.g., 5 minutes), namely, a mode of halt that is recognized as so-called “parking”. The operation includes an operation that can be performed in the halted vehicle, or an operation that is performed through the use of a space around the halted vehicle. The operation that can be performed at the vehicle halt permitting place is determined in consideration of, for example, the vastness of the vehicle halt permitting place, a facility that can be used, a surrounding environment of the vehicle halt permitting place, and the like.

According to the information processing device, for example, when desire information is acquired, halt place-associated information matching the contents of the desire information is acquired. The halt place-associated information is supplied to the vehicle. The following advantages are obtained owing to this action. For example, in the case where the vehicle is utilized as a movable shop or a business office, the vehicle may do business while making a shift in business place at intervals of a predetermined time. In accordance with the shift in business place, operations of preparation at the next business place, such as the clearance and cleaning of the interior of the vehicle, the rearrangement of the facilities in the vehicle, and the like are performed. These operations cannot be performed during the running of the vehicle, or are inefficiently performed during the running of the vehicle. Therefore, at each of the business places, business is ended a predetermined time prior to a timing of exit and the vehicle exits after making preparations on the spot, or the vehicle moves to the next business place and makes preparations at the next business place. On the other hand, at a place where the vehicle is allowed to be halted for business, it is desirable to spend as much time as possible for business and avoid sparing time for the cleanup and preparations for the following business. However, it is difficult to ensure a halt place for the vehicle somewhere else than at the business places, in order to perform non-business operations.

In the case as described above, for example, the desirer transmits desire information to the information processing device, is supplied with halt place-associated information including available vehicle halt permitting places, moves to one of the vehicle halt permitting places, halts the vehicle, and performs a desired operation. In this manner, the vehicle can be halted at a control post of the user, and the desired operation can be performed. That is, the inefficient performance of the operation in the moving vehicle or a search of a halt place can be avoided, and the operation can be efficiently performed.

The control unit may search the vehicle halt permitting place that exists in a predetermined geographical area obtained through the use of a movement start position or a movement end position of the vehicle. The movement start position of the vehicle is a position of departure for a next destination. The movement end position is a position of the destination. The position of the vehicle may be a scheduled position or a current position. The position of the vehicle may be acquired inside or outside the vehicle. The predetermined geographical area is, for example, a circle of a predetermined radius around the position of the vehicle. Alternatively, the predetermined geographical area is an area where the movement start position of the vehicle exists, among a plurality of geographical areas partitioned from one another in advance. Besides, the geographical area may be a geographical area that indicates a range of access within a predetermined time and that has been obtained through the use of a timing of the start of the movement of the vehicle from the movement start position, an average movement speed of the vehicle, or the like. The movement start position and the movement start timing can be included in, for example, the desire information. In this manner, the vehicle moves to the vehicle halt permitting place located in the predetermined geographical area, so the time and distance required for the movement of the vehicle can be made shorter than in the case where the operation is performed after dropping in at a faraway base. Thus, the amount of energy (fuel and electricity) consumed by the vehicle can be reduced.

A configuration in which the desire information includes information indicating a facility that is desired to be utilized, and the control unit acquires halt place-associated information including information indicating the vehicle halt permitting place where the facility that is desired to be utilized is available may be adopted. In other words, the halt place-associated information may include information indicating a facility that can be utilized at the vehicle halt permitting place. Further enhancement of the efficiency of the operation can be expected by utilizing the facility. The facility includes a fixed facility such as a garage (a roof), a water delivery system (a waterworks system and a sewerage system), a depository (a shed, a warehouse, or the like), a rest station, a toilet or the like, or a piece of equipment such as a wagon, a ladder, a tool, a lighting system or the like.

The facility may include a halt space for a support vehicle that supports the vehicle, the halt space for the support vehicle being different from a halt space for the vehicle. A configuration in which the control unit further carries out search of the support vehicle (a rendezvous vehicle) that can make a rendezvous with the vehicle halted at the vehicle halt permitting place, through the use of information indicating a scheduled timing of arrival of a candidate of the support vehicle at the vehicle halt permitting place and information indicating a timing of arrival of the vehicle at the vehicle halt permitting place, in a case where the desire information indicates a desire for a rendezvous between the support vehicle and the vehicle with an aid of the halt space for the support vehicle may be adopted. The rendezvous vehicle is a support vehicle that provides support in performing an operation regarding the vehicle, such as the delivery of goods between the rendezvous vehicle and the vehicle (the supply and recovery of merchandise, equipment, fuel, unwanted objects, and the like), the inspection, maintenance, repair, renovation and the like of the vehicle, or assistance such as clearance and cleaning etc. The rendezvous with the support vehicle can be made at the vehicle halt permitting place, and the operation can be more efficiently performed by receiving support from the support vehicle.

For example, when the control of a rendezvous is performed, the control unit searches a candidate of the support vehicle with the difference between the scheduled timing of arrival thereof at the vehicle halt permitting place and the timing of arrival of the vehicle at the vehicle halt permitting place being smaller than a predetermined value, as the support vehicle to make the rendezvous with the vehicle. The predetermined value is determined in consideration of, for example, the time required for the support provided by the rendezvous vehicle (the support vehicle) vis-a-vis the vehicle (the time required for the delivery of goods, the time required for the operation such as the maintenance, repair, renovation or the like of the vehicle, or the like). For example, the predetermined value can be set such that the support vehicle arrives at the vehicle halt permitting place soon after the vehicle arrives there, or that the vehicle arrives at the vehicle halt permitting place soon after the support vehicle arrives there. In this case, a sufficient time for support can be ensured during the stay of the vehicle at the vehicle halt permitting place.

A configuration in which the control unit further carries out search of a supply vehicle in which a supply to the vehicle is placed, through the use of information indicating a scheduled timing of arrival of a candidate of the supply vehicle at the vehicle halt permitting place, and information indicating a timing of arrival of the vehicle at the vehicle halt permitting place, in a case where the desire information indicates a desire to place the supply at the vehicle halt permitting place may be adopted.

The supply vehicle is a support vehicle that travels to the vehicle halt permitting place for the purpose of placing the supply to the vehicle at the vehicle halt permitting place. The supply is an object to be supplied to the vehicle via the vehicle halt permitting place. It should be noted, however, that the supply may be directly delivered through a rendezvous between the support vehicle and the vehicle. The desire information may include a desire to utilize a place for placement of the supply. The place for placement is a facility. The place for placement may not necessarily be equipped with a roof, a lid, or a locking system, although the necessity thereof depends on the attribute of the object placed there.

Besides, a configuration in which the control unit further carries out search of a recovery vehicle that recovers an unloaded object that has been unloaded from the vehicle and placed at the vehicle halt permitting place, through the use of information indicating a scheduled timing of arrival of a candidate of the recovery vehicle at the vehicle halt permitting place and information indicating a timing of arrival of the vehicle at the vehicle halt permitting place, in a case where the desire information indicates a desire to recover the unloaded object may be adopted.

The recovered object is an object that is recovered via the vehicle halt permitting place. It should be noted, however, that the recovered object may be directly recovered through a rendezvous between the support vehicle and the vehicle. The recovery vehicle is a support vehicle that travels to the vehicle halt permitting place for the purpose of recovering the unloaded object. The desire information may include a desire to utilize the place for placement of the recovered object.

By desiring the supply from the supply vehicle or the recovery by the recovery vehicle, the distance and time for moving the vehicle to a place for supply or a place for unloading goods can be shortened, and the amount of energy consumed by the vehicle can be reduced.

### Embodiment

An information processing device, an information processing method, and a program according to the embodiment will be described hereinafter with reference to the drawings. The configuration of the embodiment is an exemplification, and the disclosure is not limited to the configuration of the embodiment.

### System Configuration

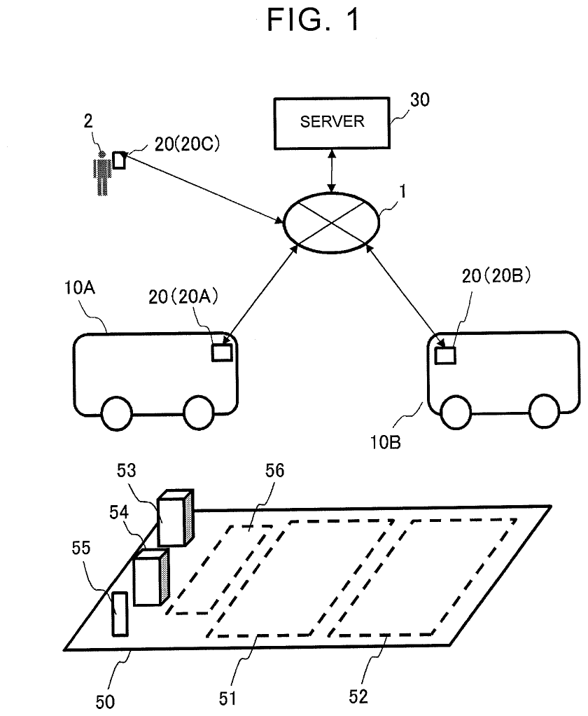

FIG. 1 is a schematic view of a system according to the embodiment. In FIG. 1, the system includes a terminal 20A, a terminal 20B, and a terminal 20C, and a server 30 that are connected to a network 1. The network 1 is, for example, a public communication network such as the Internet or the like. Wired Area Network (WAN) and other communication networks can be adopted as the network 1. Besides, the network 1 may include a cellular network such as Long Term Evolution (LTE) or the like, or a wireless network such as wireless Local Area Network (LAN) (including Wi-Fi) or the like.

The terminal 20A is an in-vehicle terminal mounted on a vehicle 10A. The vehicle 10A is utilized as a movable shop or business office that sells merchandise and that provides a service. The vehicle 10A halts at a halt position as a predetermined business place, and sells merchandise or provides the service in or around the vehicle 10A. The vehicle 10A is an example of “the vehicle”. For example, a case where the vehicle 10A is a movable shop that provides food and beverages and that sells merchandise will be described.

The terminal 20B is an in-vehicle terminal mounted on a vehicle 10B. The vehicle 10B is a support vehicle that provides support regarding the management of the movable shop using the vehicle 10A. This support includes the supply of an object (merchandise, an object contributing to the provision of a service, or the like) to the vehicle 10A, the recovery of an unwanted object (unsold merchandise and foodstuff, waste, or the like), the inspection and maintenance of the vehicle 10A, or the like.

The terminal 20C is a terminal device that is used by a user 2. The user 2 is, for example, a user of the movable shop using the vehicle 10A. The user 2 registers a land or a building of which the right to decide availability (lordship) belongs to the user and which has at least a space for halting the vehicle 10A, such as a land owned by the user 2 or the like, into the server 30 as a vehicle halt permitting place, through the use of the terminal 20C.

The server 30 acquires information indicating a plurality of vehicle halt permitting places, namely, vehicle halt permitting place information from the single user 2 or a plurality of users 2, stores this information into a database (DB), and manages the information. Incidentally, each of the users 2 can obtain a quid pro quo or an incentive from a manager or the like of the movable shop, in respect of the provision of a vehicle halt permitting place 50.

The vehicle halt permitting place 50 is schematically exemplified in FIG. 1. The vehicle halt permitting place 50 exemplified in FIG. 1 is, for example, a vacant lot belonging to the user 2, and has a halt space 51 for the vehicle 10A. Besides, the vehicle halt peimitting place 50 also has an operation space 56 where a passenger of the vehicle 10A performs some operation outside the vehicle, and a halt space 52 for the vehicle 10B as the support vehicle. Besides, the vehicle halt permitting place 50 is equipped with a shed 53, a toilet 54, and a water supply system 55 that are available to the passenger of the vehicle 10A (a clerk of the movable shop). Each of the halt space 52, the shed 53, the toilet 54, and the water supply system 55 of the support vehicle is an example of “the facility” belonging to the vehicle halt permitting place 50. Each of the halt space 52 for the support vehicle, the shed 53, the toilet 54, and the water supply system 55 is optional and may not necessarily be provided. Besides, a facility other than these may be provided.

For example, the movable shop using the vehicle 10A does business at two business places (a place (1) and a place (2)) per day. On the morning of the relevant day, the vehicle 10A leaves a base, does business at the place (1), then regards a position of the place (1) as a movement start position and a position of the place (2) as a movement end position, moves to the place (2) as a next destination, and does business at the place (2). When business is done at the place (2), the business of the day is over, and the vehicle 10A returns to the base.

At each of the place (1) and the place (2), the vehicle 10A is allowed to be halted for a time determined in advance. The vehicle 10A must exit each of the places so as not to stay there for a time longer than the time determined in advance. Besides, a distance between the place (1) and the place (2) is shorter than a distance between the place (1) and the base and a distance between the place (2) and the base.

For example, the passenger of the vehicle 10A operates the terminal 20A, creates desire information indicating a desire to utilize the vehicle halt permitting place in, for example, moving from the place (1) to the place (2), and transmits this desire information to the server 30. The DB that manages the plurality of the vehicle halt permitting places registered by the single user 2 or the plurality of the users 2 is structured in the server 30. Upon receiving the desire information from the vehicle 10A via the network 1, the server 30 conducts a search in the DB, acquires vehicle halt permitting place information matching the desire information, and outputs halt place-associated information including this vehicle halt permitting place information.

The halt place-associated information is transmitted to the terminal 20A via the network 1 and conveyed to the passenger of the vehicle 10A, as information allowing the use of the vehicle halt permitting place specified by the halt place-associated information. When the time comes to exit the place (1), the vehicle 10A moves to the vehicle halt permitting place 50 and halts in the halt space 51, in accordance with the halt place-associated information. In the halt space 51, a predetermined operation such as the clearance and cleaning of an interior of the vehicle 10A, a preparation for business at the place (2), or the like is performed. As for the operation, the passenger of the vehicle 10A can utilize the facility whose utilization has been desired by the passenger in the desire information. For example, the passenger of the vehicle 10A can use the water supply system 55, place the unwanted object in the vehicle 10A into the shed 53, or utilize the toilet 54.

As described above, the desired operation can be performed at the vehicle halt permitting place 50 that is managed by the user 2. Thus, it is unnecessary to take the time to clear and clean the vehicle 10A at the place (1). Therefore, business can be done until immediately before an exit time at the place (1), and business hours can be increased. Besides, while the vehicle 10A moves, the wasteful time spent to carry out inefficient clearance and cleaning in the jolting vehicle or look for a place for halting the vehicle 10A for the sake of clearance and cleaning can be eliminated.

Besides, a halt of both the vehicle 10A and the vehicle 10B at the vehicle halt permitting place 50, namely, a rendezvous between the vehicle 10A and the vehicle 10B can be included in the desire information. When the vehicle halt permitting place 50 where a rendezvous is possible is searched, the server 30 can search the vehicle 10B that travels to the vehicle halt permitting place 50, and transmit (request) a movement to the vehicle halt permitting place 50 to the terminal 20B of the vehicle 10B searched as a result, via the network 1. When the rendezvous is made, the vehicle 10B as a rendezvous vehicle provides support regarding the vehicle 10A. For example, a passenger of the vehicle 10B directly receives/delivers an object from/to the passenger of the vehicle 10A, helps with the clearance and cleaning of the vehicle 10A and a preparation for business, or inspects and repairs the vehicle 10A. In the case where there is no halt space 52 for the support vehicle at the place (1) or the distance from the place (1) to a place (the base) where the vehicle 10A receives support is long, the consumption of time and energy for receiving support can be suppressed by making the rendezvous.

Besides, when the halt place-associated information indicates the supply of a supply to the vehicle 10A or the recovery of an object unloaded from the vehicle 10A, the server 30 performs a process of searching the vehicle 10B as a supply vehicle or a recovery vehicle. The server 30 requests the terminal 20B of the vehicle 10B specified by a result of the search to supply the supply or recover the unloaded object, via the network 1. In response to this, the vehicle 10B moves to the vehicle halt permitting place 50, and places the supply into the shed 53 or recovers the unloaded object placed in the shed 53. Incidentally, the object may be placed at a place other than the shed 53. In this case as well, the consumption of time and energy for moving the vehicle 10A to the place where the supply is to be received or the unloaded object is placed can be suppressed.

### Configuration of Terminals

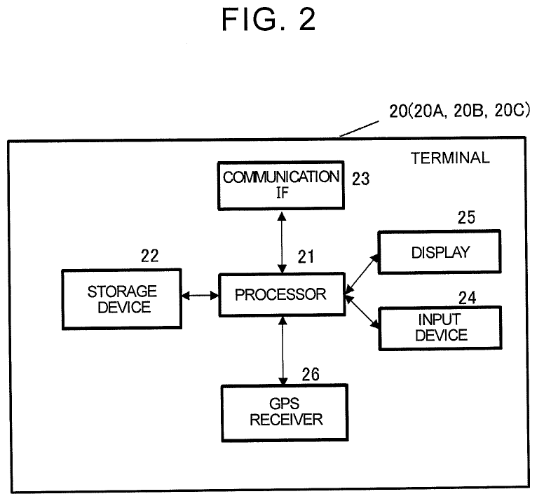

FIG. 2 shows a configuration example of each of the terminals 20 that can be used as the terminal 20A, the terminal 20B, and the terminal 20C respectively. Each of the terminals 20 may be a terminal device installed in the vehicle 10A or the vehicle 10B, or a terminal device simply mounted on the vehicle 10A or the vehicle 10B. Each of the terminals 20 may be a laptop personal computer, a smart device such as a smartphone, a tablet terminal or the like, a personal digital assistant (PDA), or a portable terminal such as a wearable computer or the like (a communication terminal exhibiting portability). In the present embodiment, it is assumed, as an example, that the terminal 20A and the terminal 20B are terminals installed in the vehicle 10A and the vehicle 10B respectively, and that the terminal 20C is a smartphone possessed by the user 2. It should be noted, however, that the terminal 20C may be a fixed terminal.

Each of the terminals 20 includes a processor 21, a storage device 22, a communication interface (communication IF) 23, an input device 24, a display 25, and a global positioning system (GPS) receiver 26.

The storage device 22 includes a main storage device and an auxiliary storage device. The main storage device is used as a storage region for a program and data, a deployment region for the program, a working region for the program, a buffer region for communication data, and the like. The main storage device is configured by a random access memory (RAM), or a combination of the RAM and a read-only memory (ROM). The auxiliary storage device is used as a storage region for data and a program. The auxiliary storage device includes, for example, a non-volatile storage medium such as a hard disk, (SSD), a flash memory, an electrically erasable programmable read-only memory (EEPROM) or the like.

The communication IF 23 is in charge of wireless communication according to a wireless communication method (LIE, 5G, wireless LAN (Wi-Fi) or the like) that is supported by the terminals 20. In the case where the terminals 20 are fixed terminals, a network interface card or the like is applicable to the communication IF 23, as the communication IF 23.

The input device 24 includes a key, a button, a pointing device, a touch panel or the like, and is used to input information. The display 25 is, for example, a liquid-crystal display or the like, and displays information and data. The GPS receiver 26 receives a signal from a GPS satellite, and calculates a position of each of the terminals 20. The position of the terminal 20A is utilized as a position of the vehicle 10A, and the position of the terminal 20B is utilized as a position of the vehicle 10B.

The processor 21 is, for example, a central processing unit (CPU) or the like. The processor 21 performs various processes by executing various programs stored in the storage device 22.

### Configuration of Server

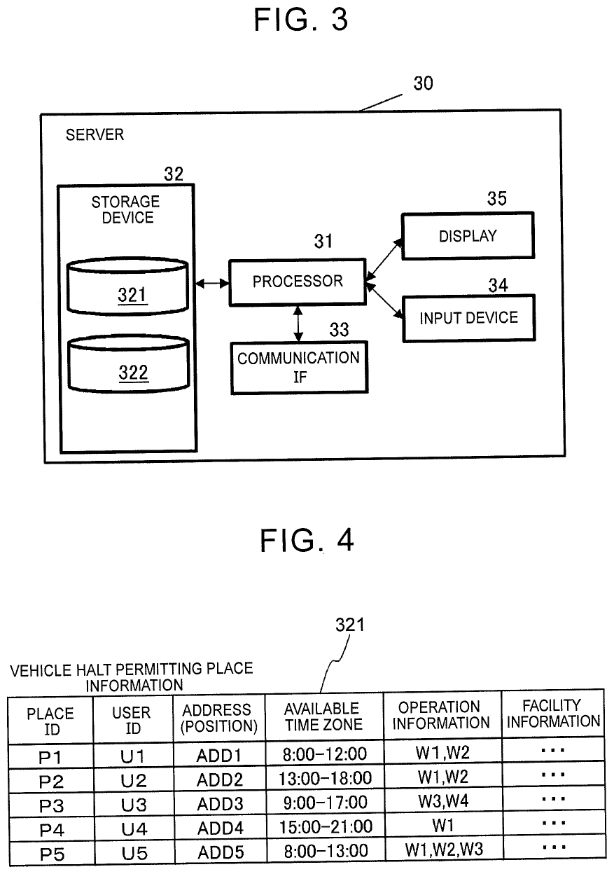

FIG. 3 shows a configuration example of the server 30. The server 30 can be configured through the use of a general-purpose information processing device such as a personal computer (PC) or a workstation, or a dedicated information processing device such as a server machine. The server 30 includes a processor 31, a storage device 32, a communication interface (communication IF) 33, an input device 34, and a display 35. The storage device 32 stores a database for vehicle halt permitting place information (information DB) 321 and a vehicle database (vehicle DB) 322. The processor 31 is an example of the control unit.

Components similar to those exemplified as the processor 21, the storage device 22, the input device 24, and the display 25 are applicable as the processor 31, the storage device 32, the input device 34, and the display 35 respectively. It should be noted, however, that components different in performance from those applied to each of the terminals 20 are applied, depending on the difference in usage or purpose of use.

The communication IF 33 is in charge of a communication process. For example, a network interface card (NIC) is applicable as the communication IF 33. The communication IF 33 transmits/receives data and information to/from the terminal 20A, the terminal 20B, and the terminal 20C via the network 1. The processor 31 causes the server 30 to operate as an information processing device for managing the vehicle halt permitting place, by executing various programs stored in the storage device 32.

Incidentally, a plurality of CPU's or a multicore-type CPU may be applied as the processor 21 or the processor 31. The process that is performed by the CPU may be at least partially performed by a processor other than the CPU such as a digital signal processor (DSP) or a graphical processing unit (GPU), a dedicated or general-purpose integrated circuit such as an application specific integrated circuit (ASIC), a field programmable gate array (FPGA) or the like, or a combination of a processor and an integrated circuit. The combination is referred to as, for example, a microcontroller (MCU), a system-on-a-chip (SoC), a system LSI, a chip set, or the like. Besides, the process that is performed by the processor 31 may be partially performed by the processor 21.

### Information DB

FIG. 4 shows a data structure example of a DB for storing vehicle halt permitting place information (referred to as an information DB) (an example of the vehicle halt permitting place information). In FIG. 4, an information DB 321 is formed by an aggregate of one or two or more records (entries) prepared for each vehicle halt permitting place 50. Each of the records includes, as elements thereof, a place ID, a user ID, an address (a position), an available time zone, an operation type, and facility information. Incidentally, in the example shown in FIG. 4, there is illustrated an example in which the vehicle halt permitting place 50 is managed per the halt space 51 (a halt space for the single vehicle 10A).

The place ID is an identifier of the vehicle halt permitting place 50. The user ID is an identifier of the user 2. The address (the position) is information indicating a location of the vehicle halt permitting place 50. The available time zone indicates a time zone in which the vehicle halt permitting place 50 is available to halt the vehicle 10A.

The operation information indicates information indicating a type of an operation that can be performed at the vehicle halt permitting place 50, and information indicating a time required for the operation. The operation type includes an operation (clearance, cleaning, a preparation for business, or the like) that is completed automatically in the vehicle 10A or only by the passenger of the vehicle 10A. Besides, the operation type also includes an operation requiring the arrival of the support vehicle (the vehicle 10B) during, before or after the use of the vehicle halt permitting place 50 by the vehicle 10A, such as “replacement of merchandise”, “the loading of a supply”, “the unloading of an unwanted object”, “inspection of the vehicle 10A” or the like. It should be noted, however, that the inclusion of the operation requiring support in the operation type is not indispensable.

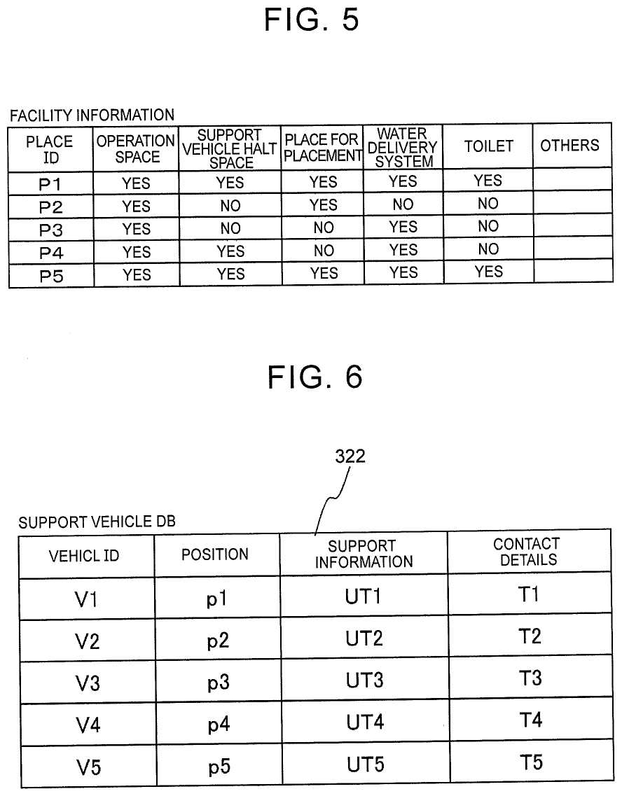

The facility information is information indicating a facility provided at the vehicle halt permitting place 50. FIG. 5 shows an example of the facility information. In the example shown in FIG. 5, information indicating the presence or absence of the operation space 56, the halt space 52 for the support vehicle, a place for placement of an object (the shed) 53, the water supply system 55, and the toilet 54 is stored as to each vehicle halt permitting place 50. Besides, the facility information further includes information indicating a piece of equipment (a wagon, a ladder, a tool or the like) provided at the vehicle halt permitting place 50.

The record in the information DB 321 is handled as a valid record in the case where the halt space 51 for the vehicle 10A at the vehicle halt permitting place 50 is vacant. In the case where the halt space 51 is in use, the record is handled as an invalid record in searching the vehicle halt permitting place 50. For example, a flag is set for the record, and the record is invalidated when the flag is on. The record may be invalidated when the flag is off.

### Support Vehicle DB

FIG. 6 shows a data structure example of the support vehicle DB 322. The support vehicle DB 322 is used to manage a plurality of vehicles 10B that are used as support vehicles. The support vehicle DB 322 is formed by one or two or more records prepared for each of the vehicles 10B. Each of the records includes, as elements thereof, a vehicle ID, support information, and contact details.

The vehicle ID is an identifier of the vehicle 10B as the support vehicle. The position indicates the position of the vehicle 10B. The support information includes information indicating the contents of support that can be provided by the vehicle 10B, and information indicating a supply that can be supplied during support. The contact details include a network address of the terminal 20B mounted on the vehicle 10B.

### Processing Example

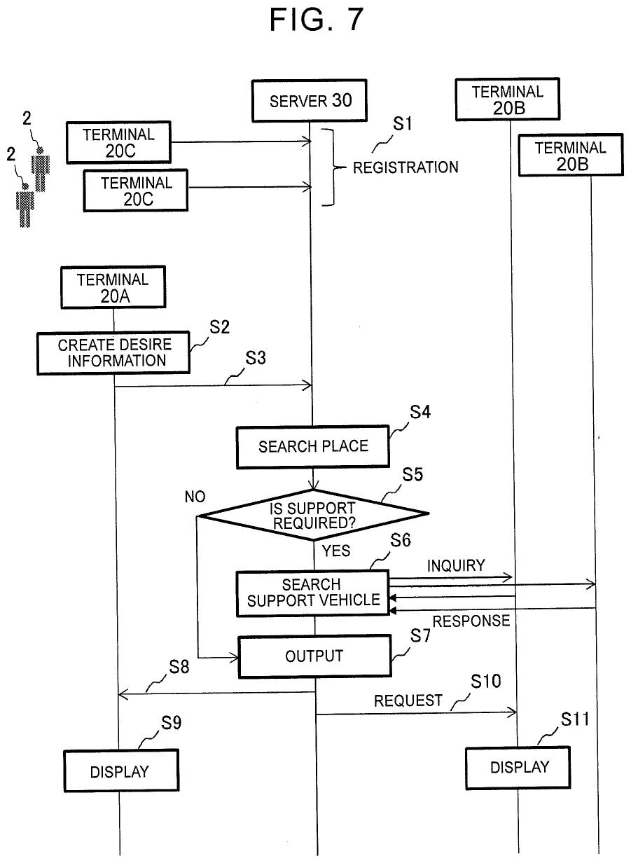

FIG. 7 is a flowchart showing an exemplary process that is performed by a computer system including the server 30, the terminal 20C, the terminal 20A, and the terminal 20B. In the present embodiment, each of the users 2 inputs vehicle halt permitting place information into the terminal 20C, and the terminal 20C transmits the vehicle halt permitting place information to the server 30 via the network 1. A network address of the server 30 is known to the terminal 20C.

The processor 31 of the server 30 registers (stores) the vehicle halt permitting place information into the information DB 321 formed in the storage device 32 (S1). The vehicle halt permitting place information includes a user ID, an address, an available time zone, operation information, and facility information.

It is assumed that the passenger of the vehicle 10A temporarily returns to the base and then performs a predetermined operation in moving between business places (e.g., moving from the above-mentioned place (1) to the above-mentioned place (2)). In this case, time and energy for movement (fuel and electricity) may be lost through the movement from the place (1) to the base and the movement from the base to the place (2). In such a case, the passenger desires the operation close to the place (1) or the place (2), or at the vehicle halt permitting place 50 located on a movement path from the place (1) to the place (2). The passenger operates the terminal 20A, creates desire information (S2), and transmits the desire information to the server 30 via the network 1 (S2).

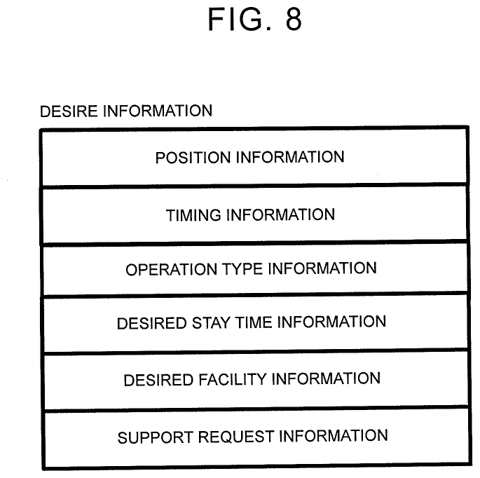

FIG. 8 is an illustrative view of desire information. The desire information includes position information, departure timing information, operation type information, desired stay time information, desired facility information, and support request information. The position information indicates a departure position (a movement start position) of the terminal 20A (the vehicle 10A). The departure timing information indicates a start timing of movement from the departure position. For example, the position information is information on the place (1), and the timing information indicates a timing of departure from the place (1). The position information and the timing information may be scheduled information that is determined from a business schedule of the movable shop of the vehicle 10A, or a current position at a current timing acquired through the use of the GPS receiver 26.

The operation type information indicates the type and contents of an operation that is performed at the vehicle halt permitting place 50. The desired stay time information indicates a time during which the vehicle 10A is desired to stay at the vehicle halt permitting place 50. The desired facility information indicates a facility that is desired to be used at the vehicle halt permitting place 50. The desired facility information is not included in the case where no facility is desired to be utilized. The support request information indicates a request for support by the support vehicle (the vehicle 10B). The support request information is not included in the case where no support is required.

The support request information includes information indicating a type such as “a pre-arrival countermeasure”, “a rendezvous countermeasure”, and “a post-exit countermeasure” and the contents of requested support. Besides, the support request information further includes information indicating an object (a supply) that is desired to be supplied, in the case where the contents of support indicate the supply of the object. “The pre-arrival countermeasure” indicates a desire for a support operation before the arrival of the vehicle 10A at the vehicle halt permitting place 50. For example, this countermeasure consists in placing the supply at a place for placement in advance in preparation for the arrival, etc. “The rendezvous countermeasure” indicates a desire to perform the support operation while the vehicle 10A is halted at the vehicle halt permitting place 50. For example, this countermeasure consists in the clearance and cleaning of the interior of the vehicle 10A, assistance in changing arrangement, the direct delivery and receipt of an object, and the maintenance, inspection, and repair of the vehicle 10A, or the like. “The post-arrival countermeasure” indicates a desire for the support operation after the exit of the vehicle 10A from the vehicle halt permitting place 50. For example, this countermeasure consists in recovering the object unloaded from the vehicle 10A, or the like.

In the case where the support request information is “the rendezvous countermeasure”, the operation type information indicates the type of an operation that is performed after making a rendezvous. The desired facility information includes a desire to utilize the halt space 52 for the support vehicle. In the case where the support request information is “the pre-arrival countermeasure”, the operation type information indicates the type of an operation including the loading of the supply placed at the vehicle halt permitting place 50, and the desired facility information includes a desire to utilize the place for placement of the supply (the shed 53). In the case where the support request information is “the post-arrival countermeasure”, the operation type information indicates the type of an operation of placing the unloaded object unloaded from the vehicle 10 at the vehicle halt permitting place 50, and the desired facility information includes a desire to utilize the place for placement of the unloaded object (the shed 53).

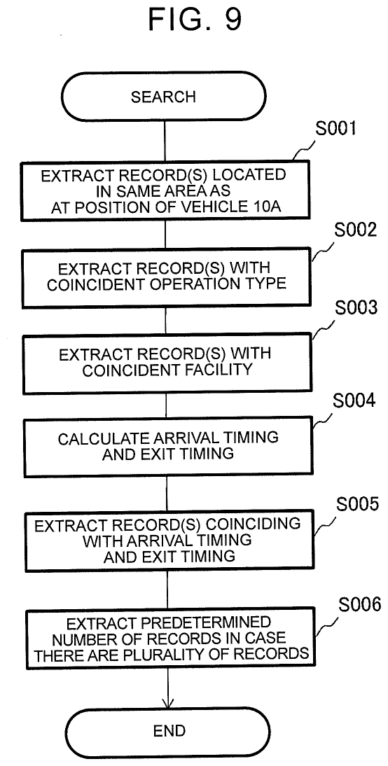

In the server 30 that has received the desire information, the processor 31 accepts the desire information, and conducts a search of the vehicle halt permitting place 50 (S4). FIG. 9 is a flowchart showing an exemplary process of searching the vehicle halt permitting place 50.

In S001, the processor 31 extracts records with a predetermined geographical area including the position of the vehicle 10A included in the desire information, from among a plurality of records on vehicle halt permitting place information belonging to the information DB 321. For example, a circle of a predetermined radius around the position of the vehicle 10A is applied as the geographical area. The processor 31 extracts at least one record on the vehicle halt permitting place 50 where there is an address within this circle. The method of calculating the area should not be limited to the above-mentioned one.

In S002, the processor 31 extracts at least one record having operation information that coincides with the type of the operation in the desire information (that makes it possible to perform a desired operation) from among the at least one record extracted in S001.

In S003, the processor 31 extracts at least one record on the vehicle halt permitting place 50 that is equipped with a facility that is desired to be used (where the facility can be used) as included in the desire information. It should be noted, however, that the processing of S003 is skipped when the desire information does not include a desire to use any facility.

In S004, the processor 31 calculates, as to each record, an arrival timing and an exit timing regarding the vehicle halt permitting place 50 indicated by each record. That is, the processor 31 calculates a time for movement between the position of the vehicle 10A and a position of the vehicle halt permitting place 50 that is indicated by an address in each record, and calculates a scheduled timing of arrival of the vehicle 10A as a timing of arrival thereof at the vehicle halt permitting place 50. Besides, the processor 31 calculates a timing after the lapse of a desired time of stay or a time obtained by adding a predetermined margin to this desired time of stay, which is included in the desire information, from the arrival timing, as a timing of exit of the vehicle 10A from the vehicle halt permitting place 50.

In S005, the processor 31 extracts at least one record coinciding with a time (a stay time) from the arrival timing to the exit timing, namely, at least one record where the arrival timing and the exit timing fall within an available time zone.

In S006, when a plurality of records are extracted in S005, a predetermined candidate number (a number equal to 1 or 2 or more) of records are extracted according to a rule determined in advance. In the present embodiment, there is illustrated an example in which a single record is extracted. There is no particular restriction on the rule. For example, however, a record indicating the vehicle halt permitting place 50 located closest to the position of the vehicle 10A is extracted. This aims at accelerating the timing of starting a predetermined operation such as clearance, cleaning or the like. Upon the end of S006, the process of searching the vehicle halt permitting place 50 ends. Incidentally, when a single record is extracted in S005, S006 is omitted.

In S5, the processor 31 determines whether or not the vehicle 10A needs to be supported. For example, the processor 31 determines whether or not support is required, by determining whether or not support request information is included in the desire information. If it is determined that support is not required, the process proceeds to S7. In contrast, if it is determined that support is required, the process proceeds to S6, and a process of searching a support vehicle is performed.

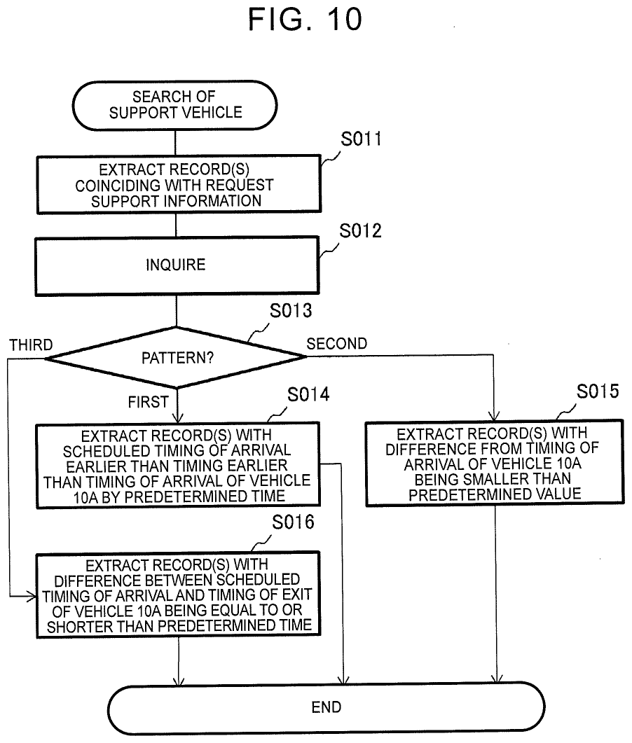

FIG. 10 is a flowchart showing an exemplary process of searching a support vehicle. In S011, the processor 31 extracts at least one record including support information that coincides with information indicating the contents of requested support in the support request information included in the desire information, from the support vehicle DB 322.

In S012, the processor 31 performs a process of inquiry. That is, the processor 31 transmits an inquiry about the availability of support to the terminal 20B of the at least one vehicle 10B, through the use of contact details included in the at least one record extracted in S011. The inquiry includes the address of the vehicle halt permitting place 50.

The processor 21 of the terminal 20B that has received the inquiry causes, for example, the display 25 to display the inquiry about the availability of support and the address. An operator of the terminal 20B inputs the availability of support, a scheduled timing of arrival of the vehicle 10B at the vehicle halt permitting place 50 in the case where support is available, and contact details of the vehicle 10B (a phone number and a mail address) to the terminal 20B, through the use of the input device 24. Incidentally, the processor 21 may automatically calculate the scheduled timing of arrival of the vehicle 10B, using the position of the terminal 20B (the vehicle 10B) acquired through the use of the GPS receiver 26 and the address of the vehicle halt permitting place 50. Besides, the server 30 may be informed of the position of the vehicle 10B and calculate the scheduled timing of arrival thereof.

When the information indicating that support is available is input to the processor 21, the processor 21 transmits a response including the information indicating that support is available, the scheduled timing of arrival, and the contact details of the vehicle 10B to the server 30. When the information indicating that support is unavailable is input to the processor 21, the processor 21 gives no response.

Upon receiving the response, the processor 31 of the server 30 advances the process to S013. In S013, the processor 31 determines whether the pattern of support indicated by the support request information is a first pattern (i.e., “the pre-arrival countermeasure”), a second pattern (i.e., “the rendezvous countermeasure”), or a third pattern (i.e., “the post-exit countermeasure”). If it is determined that the pattern of support is the first pattern, the process proceeds to S014. If it is determined that the pattern of support is the second pattern, the process proceeds to S015. If it is determined that the pattern of support is the third pattern, the process proceeds to S016.

In S014, the processor 31 extracts at least one record on the vehicle 10B with the scheduled timing of arrival thereof being earlier than a timing that is earlier than the timing of arrival of the vehicle 10A calculated in S004 by a predetermined time, from among the at least one record extracted in S011 (the at least one record on the candidate of the supply vehicle). The predetermined time is determined in consideration of the time for the vehicle 10B to place a supply at the place for placement (e.g., the shed 53) at the vehicle halt permitting place 50. When a plurality of records are extracted, the record with the earliest scheduled timing of arrival of the vehicle 10B is extracted from among the plurality of the records. The vehicle 10B that is specified by the record extracted in S014 is determined as the support vehicle (the supply vehicle).

In S015, the processor 31 extracts at least one record on the vehicle 10B with the difference between the scheduled timing of arrival of the vehicle 10B and the timing of arrival of the vehicle 10A calculated in S004 being smaller than a predetermined value, from among the at least one record extracted in S011 (the at least one record on the candidate of the rendezvous vehicle). The predetermined value is determined in consideration of an operation time for support of the vehicle 10A by the vehicle 10B. When a plurality of records are extracted, the record with the smallest difference is extracted. The vehicle 10B that is specified by the record extracted in S015 is determined as the support vehicle (the rendezvous vehicle).

In S016, the processor 31 extracts at least one record on the vehicle 10B with the difference between the scheduled timing of arrival of the vehicle 10B and the timing of exit of the vehicle 10A calculated in S004 being equal to or shorter than a predetermined time, from among the at least one record extracted in S011 (the at least record on the candidate of the recovery vehicle). The predetermined time is determined such that the time during which the unloaded object is placed at the vehicle halt permitting place 50 becomes short, in consideration of a timing when the vehicle 10A finishes unloading the unloaded object, a time required to recover the unloaded object, and the like. When a plurality of records are extracted, the record with the earliest scheduled timing of arrival of the vehicle 10B is extracted from among the plurality of the records. The vehicle 10B that is specified by the record extracted in S016 is determined as the support vehicle (the recovery vehicle). Incidentally, the vehicle 10B with the scheduled timing of arrival thereof being later than a timing that is earlier than the timing of exit thereof by a predetermined time may be determined as the recovery vehicle. Upon the end of the processing of S014, S015, and S016, the process proceeds to S7.

Incidentally, the processing of S004 and S005 in the process of searching the vehicle halt permitting place 50 is optional. In the case where the processing of S004 and S005 is omitted from the process of searching the vehicle halt permitting place 50, the processing of calculating the timing of arrival or exit of the vehicle 10A is performed before and after S011, immediately after S012, or immediately before S014, S015, and S016, in the process of searching the support vehicle.

In S7, a process of outputting information is performed. That is, the processor 31 outputs information including the address of the vehicle halt permitting place 50, the available time zone, and the facility information, as halt place-associated information, based on a result of search of the vehicle halt permitting place 50. The halt place-associated information is transmitted to the terminal 20A of a transmission source of the desire information (S8). For example, a network address of the transmission source of the desire information is used as a network address of the terminal 20A of the transmission source. In the case where the process of searching the support vehicle (S6) is performed, contact details of the vehicle 10B (a phone number and a mail address) are included in the halt place-associated information.

At the terminal 20A of the transmission source, the processor 21 causes the display 25 to display the contents of the halt place-associated information (S9). Thus, the passenger of the vehicle 10A can be informed of the address (position) of the vehicle halt permitting place 50, move from the place (1) to the vehicle halt permitting place 50, halt the vehicle 10A at the vehicle halt permitting place 50, and perform a desired operation. At this time, it is also possible to use the facility located at the vehicle halt permitting place 50.

Besides, when the process of searching the support vehicle (S6) is performed, the processor 31 transmits a request for support to the terminal 20B of the vehicle 10B corresponding to the result of search, through the use of the contact details (S10). The request for support includes the fact that the vehicle 10B has been determined as the support vehicle, the address of the vehicle halt permitting place 50, and the contact details of the vehicle 10A (the phone number and the mail address, which are included in the desire information). The terminal 20B that has received the request causes the display 25 to display the contents of the request (S11). In response to the request, the vehicle 10B travels toward the vehicle halt permitting place 50 to support the vehicle 10A.

Incidentally, when the halt place-associated information is transmitted to the terminal 20A, the processor 31 of the server 30 removes the stay time calculated in S004 from the available time zone in the record corresponding to the halt place-associated information. At this time, when the length of time indicated by the available time zone is shorter than a predetermined value, the processor 31 invalidates the record. This is because there occurs a situation where the vehicle 10A cannot be halted (there is no vacancy) at the vehicle halt permitting place 50 for a time sufficient to perform the operation.

Incidentally, in the present embodiment, as described above, it is assumed that the halt space 51 for the single vehicle 10A is managed as a single record in the information DB 321. It should be noted, however, that the adoption of a configuration in which a plurality of halt spaces 51 that are close to one another (e.g., located on the same premises) are managed as a single record and the number of haltable vehicles and the time zone are updated according to the current status of utilization is acceptable.

Besides, in the present embodiment, the configuration in which the halt place-associated information on the single vehicle halt permitting place 50 is transmitted to the terminal 20A is exemplified. It should be noted, however, that information on a plurality of vehicle halt permitting places 50 may be transmitted to the terminal 20A, and that the operator of the terminal 20A (the passenger of the vehicle 10A) may select one of the vehicle halt permitting places 50 with reference to the halt place-associated information.

Besides, the process exemplified in FIG. 10 assumes a case where the vehicle halt permitting place 50 having the halt space 52 for the support vehicle is determined, in the process of searching the vehicle halt permitting place 50. That is, in the case where the support request information is included in the desire information, the processor 31 searches the vehicle halt permitting place 50 having the halt space 52, independently of the first to third patterns.

In contrast, there may be no vehicle halt permitting place 50 having the halt space 52 for the support vehicle. In this case, the processor 31 sets the predetermined time in S014 as a length of time ensuring the performance of an operation of halting the support vehicle in the halt space 51 for the vehicle 10A and placing a supply. Besides, the processor 31 establishes a setting in which the vehicle 10B halts in the halt space 51 for the vehicle 10A and the vehicle 10A arrives there after the vehicle 10B places the supply and exits. Besides, in S016, the processor 31 performs the process of determining, as the support vehicle (the recovery vehicle), the vehicle 10B with the scheduled timing of arrival thereof at the vehicle halt permitting place 50 being later than the timing of exit of the vehicle 10A.

### Effect of Embodiment

According to the embodiment, the processor 31 of the server 30 transmits the halt place-associated information on the vehicle halt permitting place 50 coinciding with the desire information on the vehicle 10A to the terminal 20A (the vehicle 10A). Thus, the vehicle 10A travels toward the vehicle halt permitting place 50, and performs the desired operation. Thus, the vehicle 10A can avoid the clearance and cleaning of the interior thereof at the place (1), prolong the business hours at the place (1), and increase sales. The amount of wasted time and wasted energy can be reduced by avoiding a return to the base for the sake of operation.

Besides, when the vehicle 10A desires support, the support vehicle arrives at the vehicle halt permitting place 50, and the vehicle 10A can receive the desired support. A special advantage is gained when there is no halt space for the support vehicle at the place (1) or the place (2). For example, a large refrigerator or freezer is needed to preserve food in the case where the vehicle 10A is a mobile restaurant. In this case, the need for such an in-vehicle facility can be eliminated by providing food at the vehicle halt permitting place 50. Besides, it is also possible to avoid the operation of washing dishes and cooking equipment, and avoid the emergence of foul water and other treatment operations by, for example, replacing the used dishes and cooking equipment with unused ones through a rendezvous with the support vehicle. Besides, it is also possible to place a tank containing the foul water used for washing in the shed 53, and cause the support vehicle to recover the tank therefrom.

### Others

The above-mentioned embodiment is nothing more than an example. The disclosure can be carried out after being appropriately altered within such a range as not to depart from the gist thereof.

Besides, any process described as being performed by a single device may be performed by a plurality of devices in a sharing manner. Alternatively, any processes described as being performed by different devices may be performed by a single device. The type of a hardware configuration (server configuration) that realizes respective functions in a computer system can be flexibly altered.

The disclosure can also be realized by supplying a computer with a computer program that is endowed with the functions described in the above-mentioned embodiment, and causing at least one processor belonging to the computer to read out and execute the program. This computer program may be provided to the computer by a non-transitory computer-readable storage medium that can be connected to a system bus of the computer, or may be provided to the computer via a network. The non-transitory computer-readable storage medium includes, for example, any type of disk such as a magnetic disk (a floppy® disk, a hard disk drive (HDD) or the like), an optical disk (a CD-ROM, a DVD disk, a blu-ray disk, or the like), or a read only memory (ROM), a random access memory (RAM), an EPROM, an EEPROM, a magnetic card, a flash memory, an optical card, or any type of medium suited to store electronic commands.

What is claimed is:

1. An information processing device comprising:
a control unit that carries out
acquisition of desire information including information indicating an operation that is performed during halt of a vehicle, and information indicating a time during which the vehicle is desired to be halted,
acquisition of halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place, and
output of the halt place-associated information.

2. The information processing device according to claim 1, wherein
the control unit searches the vehicle halt permitting place that exists in a predetermined geographical area obtained through use of a movement start position or a movement end position of the vehicle.

3. The information processing device according to claim 1, wherein
the desire information includes information indicating a facility that is desired to be utilized, and
the control unit acquires halt place-associated information including the vehicle halt permitting place where the facility that is desired to be utilized is available.

4. The information processing device according to claim 3, wherein
the facility that is desired to be utilized includes a halt space for a support vehicle that supports the vehicle, the halt space for the support vehicle being different from a halt space for the vehicle, and
the control unit further carries out search of the support vehicle that can make a rendezvous with the vehicle halted at the vehicle halt permitting place, through use of information indicating a scheduled timing of arrival of a candidate of the support vehicle at the vehicle halt permitting place and information indicating a timing of arrival of the vehicle at the vehicle halt permitting place, in a case where the desire information indicates a desire for a rendezvous between the support vehicle and the vehicle with an aid of the halt space for the support vehicle.

5. The information processing device according to claim 4, wherein
the control unit searches a candidate of the support vehicle with a difference between the scheduled timing of arrival thereof at the vehicle halt permitting place and the timing of arrival of the vehicle at the vehicle halt permitting place being smaller than a predetermined value, as the support vehicle to make a rendezvous with the vehicle.

6. The information processing device according to claim 3, wherein
the control unit further carries out search of a supply vehicle in which a supply to the vehicle is placed, through use of information indicating a scheduled timing of arrival of a candidate of the supply vehicle at the vehicle halt permitting place, and information indicating a timing of arrival of the vehicle at the vehicle halt permitting place, in a case where the desire information indicates a desire to place the supply at the vehicle halt permitting place.

7. The information processing device according to claim 3, wherein
the control unit further carries out search of a recovery vehicle that recovers an unloaded object that has been unloaded from the vehicle and placed at the vehicle halt permitting place, through use of information indicating a scheduled timing of arrival of a candidate of the recovery vehicle at the vehicle halt permitting place and information indicating a timing of arrival of the vehicle at the vehicle halt permitting place, in a case where the desire information indicates a desire to recover the unloaded object.

8. An information processing method comprising:
acquiring desire information including information indicating an operation that is performed during halt of a vehicle, and information indicating a time during which the vehicle is desired to be halted,
acquiring halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place, and
outputting the halt place-associated information.

9. A program that causes an information processing device to carry out
acquisition of desire information including information indicating an operation that is performed during halt of a vehicle, and information indicating a time during which the vehicle is desired to be halted,
acquisition of halt place-associated information matching the desire information, namely, halt place-associated information including information indicating a vehicle halt permitting place that is managed by a user, information indicating a time during which the vehicle halt permitting place is available, and information indicating an operation that can be performed at the vehicle halt permitting place, and
output of the halt place-associated information.
